(19) United States
(12) Patent Application Publication
(10) Pub. No.: US 2002/0011374 A1
(43) Pub. Date: Jan. 31, 2002

(54) Small motorized cart and brush cage apparatus

(76) Inventor: Charles Brister, Amite, LA (US)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002

(21) Appl. No.: 09/816,973

(22) Filed: Mar. 23, 2001

Related U.S. Application Data
(60) Provisional application No. 60/191,972, filed on Mar. 24, 2000.

(51) Int. Cl. B60K 3/00; B60K 5/00

(52) U.S. Cl. 180/291; 180/312

(57) ABSTRACT

A small motorized cart apparatus or “go-cart” apparatus includes an improved brush cage arrangement that covers and protects a user during operation, enveloping the user above and on the sides of a user occupying the driver's seat. The brush cage is pivotally attached at the front of the cart apparatus near the front, steerable wheels. A seat back tube extends along the sides of and over the top of the driver's seat. A latch mechanism includes locking parts on the brush cage and on the seat back tube that form a rugged connection that is preferably positioned just above the head of the driver when the brush cage is in a lowered position. This enables the driver to use one hand to release the mechanism when the cage is to be opened. One or two hands can be used to grab the cage to pull it down toward the driver and into engagement with the locking mechanism on the seat back tube when a closed position is desired for the brush cage.

### CROSS-REFERENCE TO RELATED APPLICATIONS

Priority of U.S. Provisional Patent Application Serial No. 60/191,972, filed Mar. 24, 2000, incorporated herein by reference, is hereby claimed.

### DEVELOPMENT

Not applicable

### REFERENCE TO A “MICROFICHE APPENDIX”

Not applicable

### BACKGROUND OF THE INVENTION

1. Field of the Invention

The present invention relates to small motorized carts that are typically powered with small, rear mounted internal combustion engines that are in the range of between about one (1) and fifteen (15) horsepower and wherein a drive rotates one or both rear wheels, the apparatus including a movable cage arrangement that is specially configured to protect the full length of the driver's body from tree limbs, brush, etc. during use.

2. General Background of the Invention

Small, motorized carts have been commercially available for many, many years. These carts typically provide a chassis that is positioned very close to the ground, clearance being in the range of about 5-10 inches. The chassis has front and rear axles and a plurality of wheels, typically including two front steerable wheels and two rear wheels which are driven.

These small motorized carts are known by the slang term “go cart” and are sold commercially by numerous companies including Karts International of Roseland, La.; Manco Products, Inc. of Fort Wayne, Ind.; Carter Brothers Mfg. Co., Inc., of Brundidge, Ala.; and Midwestern Industries, of New Paris, Ind.

Many small motorized carts are used in an off-road environment that is forested or treed. For example, hunters and fisherman use such small motorized carts or go-carts to gain access to their favorite wilderness areas. In such an environment, trees, brush, bushes, and tall weeds can be an aggravation to the operator as he or she tries to negotiate ATV (all terrain vehicle) trails, and like pathways.

Various patents have issued for go cart arrangements. The Brister U.S. Pat. Nos. 5,477,940, 5,797,468, 5,597,048, and 5,913,178 are directed to a safety device that disengages the throttle of a go cart when a user inadvertently hits the brake and throttle at pedals at the same time. The Brister U.S. Pat. No. 5,328,011 is directed to a chain driven cart and its clutch assembly.

Other patents that are related to small, motorized carts or “go carts” include:

U.S. Pat. No. 5,961,135 entitled “Go-Cart Frame and Wheel Suspension”; U.S. Pat. No. Des. 412,138, entitled “Body-Shell Design for A Racing Go-Cart Vehicle”; U.S. Pat. No. Des. 408,869, entitled “Go-Cart Frame”; U.S. Pat. No. 5,740,878, entitled “Miniaturized Single-Seater Motor-Vehicle, in Particular for Sports and Recreative Use”; U.S. Pat. No. Des. 373,976, entitled “Go Cart”; U.S. Pat. No. 5,462,300, entitled “Go-Cart Restrainer”; U.S. Pat. No. 4,896,899, entitled “Go-Cart Vehicle”; and U.S. Pat. No. 4,682,668, entitled “Go-Cart”.

### BRIEF SUMMARY OF THE INVENTION

The present invention provides a go cart apparatus that has a chassis having a seat with a seat base and a seat back. The chassis is wheeled, providing a pair of front steerable wheels and a pair of rear wheels. A seat back tube extends upwardly from the remainder of the chassis to an elevated position that preferably extends above the seat back. The seat back tube can be in the form of a pair of generally vertically extended members that extend along opposing sides of the seat back and a transverse member that extends across the top of the seat back, being connected to the two vertical portions of the seat back member. The seat back tube can be one continuous, bent tube.

An engine is mounted on the chassis behind the seat back. A known transmission interfaces the engine with at least one of the rear wheels for driving the rear wheels. A centrifugal clutch can be a part of the transmission.

A steering mechanism is provided for steering the front wheels and including a steering member that is positioned next to the seat and generally above and in front of the seat base.

A brush cage is movably mounted to the chassis at the front of the chassis and next to the front wheels. The brush cage is movable between lowered and elevated positions. The cage includes an inclined portion that extends from a position next to the front wheels to a position above and behind the steering member.

A locking or latching mechanism secures the cage in the lowered position. The locking or latching mechanism is preferably a releasable mechanism that enables the operator or driver to unlock the mechanism with one hand by engaging a lever or other release mechanism that is part of the locking mechanism.

In the preferred embodiment, the locking mechanism is positioned above the seat back and can be attached to the seat back tube.

The locking mechanism preferably includes first and second locking members that include one locking member mounted on the chassis and another locking member mounted on the cage.

The seat back tube preferably extends along opposing sides of the seat back and includes a generally transverse tube member that is positioned at the top of the seat back member above the operator's head during use.

One of the locking members is preferably attached to the transverse tube member of the seat back tube.

The cage is preferably comprised of a pair of primary tube members and a pair of secondary tube members, each secondary tube member being connected at spaced apart positions to a primary tube member, wherein the primary tube members are movably attached to the chassis.

The primary tube members are preferably pivotally attached to the chassis at a position next to the front wheels.

An improved steering arrangement provides a “t” shaped bar that communicates with an upper steering rod section and a lower steering rod section. The steering rod sections are connected by a universal joint.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a perspective view of the preferred embodiment of the apparatus of the present invention showing the brush cage portion in a lowered, operating position;

FIG. 2 is a perspective view of the preferred embodiment of the apparatus of the present invention, showing the brush cage in an upper, open position;

FIG. 3 is a perspective, fragmentary view illustrating a locking latch portion of the preferred embodiment of the apparatus of the present invention; and

FIG. 4 is a partial perspective view of the preferred embodiment of the apparatus of the present invention;

FIG. 5 is a partial perspective view of the preferred embodiment of the apparatus of the present invention.

### DETAILED DESCRIPTION OF THE INVENTION

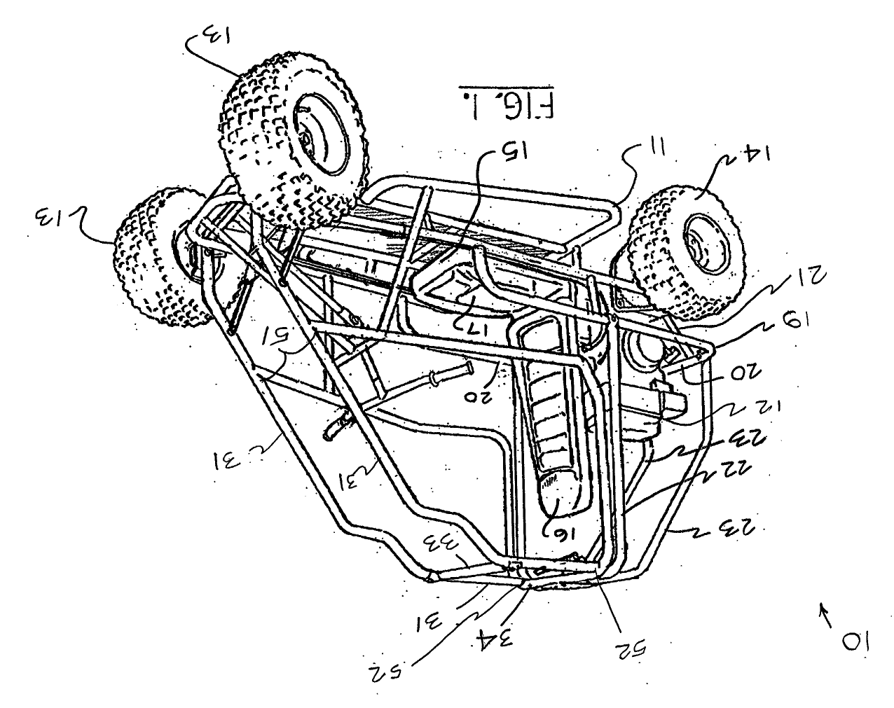

FIGS. 1-5 show the preferred embodiment of the apparatus of the present invention designated generally by the numeral 10. Small, motorized cart 10 includes a chassis 11 having a rear mounted engine 12. The chassis 11 can be provided with front and rear axles. The front axle carries a pair of front, steerable wheels 13. The rear axle carries a pair of rear wheels 14 that can be driven by a suitable transmission, such as a centrifugal clutch (see U.S. Pat. No. 5,603,397, incorporated herein by reference).

The apparatus 10 is provided with a seat 15 that includes a seat back 16 and a seat base 17. The seat base 17 can be mounted in a sliding, adjustable fashion on a pair of spaced apart rails 18.

An engine guard 19 extends upwardly and rearwardly of the chassis 11. The engine guard 19 can be comprised of a plurality of connected horizontal tubes 20 supported in an elevated position by a plurality of diagonal tubes 21. A seat back tube 22 extends up from the horizontal tubes 20 of engine guard 19. The seat back tube 22 can generally U-shaped providing a plurality of tubular members that are connected end to end to form a “U”.

A pair of rear tubes 23 extend from engine guard 19 at a position behind engine 12 upwardly to connect with the uppermost portion of seat back tube 22 (see FIGS. 1-3).

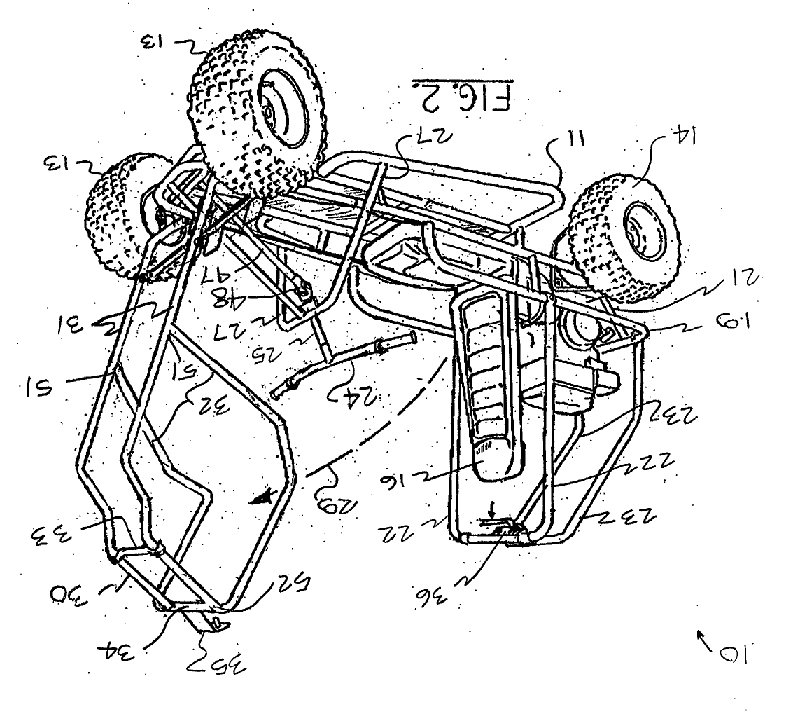

A steering bar 24 attaches to steering column 25. Steering column 25 connects to a suitable front wheel steering mechanism 26 such as a rod and lever steering mechanism, rack and pinion steering mechanism, or other steering mechanism for steering front wheels 13. A steering column support 27 can be in the form of a plurality of tubes as shown in FIG. 2 that are welded together. The support 27 can be welded to chassis 11. Support 27 includes a portion that extends up to steering column 25. A suitable bearing tube can be placed at the upper end portion of steering column support 27 to form an interface between the static tube portions of steering column support 27 and steering column 25. Bar 42 is a transverse bar having opposed handles 43. Bar 42 is welded to upper steering column section 44 that is rotatably mounted in sleeve 45. Sleeve 45 is welded or otherwise attached to steering support 27. Universal joint 48 is attached to the lower end of upper steering column section 44. A lower steering column section 47 is attached at its upper end to universal joint 48 and at its lower end to steering lever 49. Steering lever 49 connects to rods 50 that steer wheels 13. Upper steering column section 44 can have a greater inclination than lower steering column section 47.

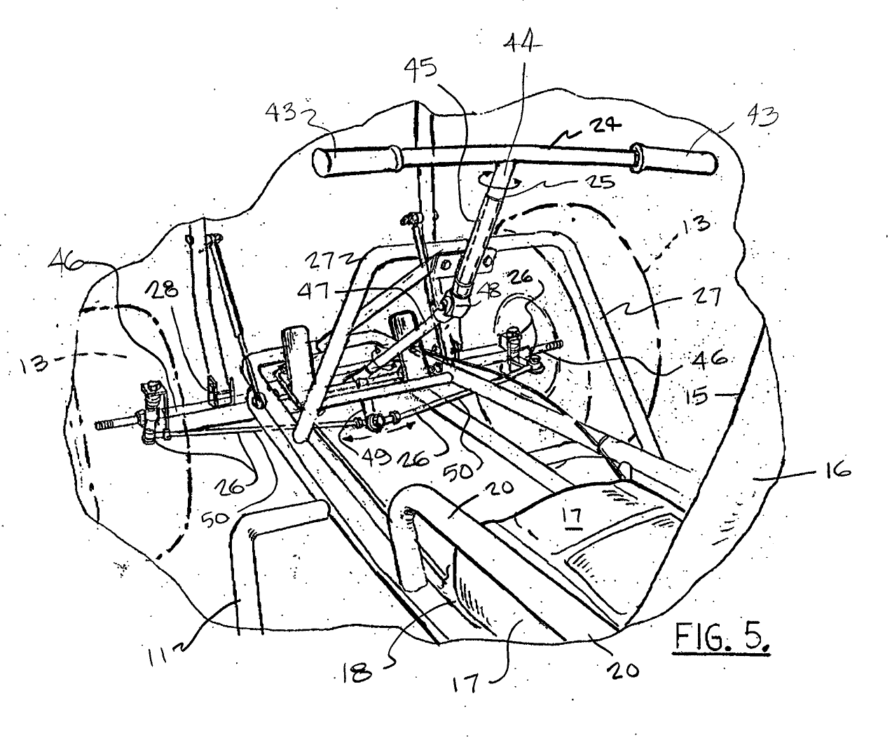

Brush cage 30 can be a welded or bolted, preferably tubular construction that pivots between an operating, lower driving position as shown in FIG. 1 to an upper, open position as shown in FIG. 2. In FIG. 2, arrow 29 indicates schematically the rotation of brush cage 30 about its pivots 28 (see FIG. 5) to the open position of FIG. 2. Two pivots 28 can be provided on axle 46. Brush cage 30 provides full length protection for the driver's body and can be gripped and opened by a driver seated upon seat 15 even though the driver is in a driving position. This is accomplished by the special configuration of the brush cage 30 including the geometry of the various tubular members that comprise the brush cage 30.

In FIG. 1, brush cage 30 includes a pair of primary, longitudinal tubes 31 that extend from pivots 28 along an inclined path to meet with transverse tubes 33, 34. A pair of secondary longitudinal tubes 32 extend along a generally horizontal path from a position near the front of primary, longitudinal tubes 31 at welded or bolted connection 51, to a position near the rear of primary longitudinal tubes 31 at welded connection 52.

At the rear, upper end portion of brush cage 30, transverse tube 34 connects to the rear intersection of the primary, longitudinal tubes 31 and the secondary longitudinal tubes 32. A commercially available latch member 35 is provided on brush cage 30 at transverse tube 34 for forming a connection with a cooperating commercially available latch member 36 on seat back tube 22.

In FIG. 3, latch member 36 can include a locking arm 37 having that enables a user's hand 38 to grip the arm 37 and move it for releasing the latch member 35 and moving the brush cage 30 to the open position of FIG. 2.

In order to open the brush cage 30 to the elevated position of FIG. 2, a user pulls the locking arm 37. The latch member 35 is spring loaded to return to a locking closed position. The user overcomes this spring force when pulling the arm 37 in order to disengage the post 39 from slot 40 of latch member 35.

The locking arrangement shown in FIGS. 1-3 is preferably centered about the driver's head. By placing the locking arm 37 immediately above seat back 16 and thus the driver's head, it can be easily gripped for releasing the brush cage 30 using only one hand 38.

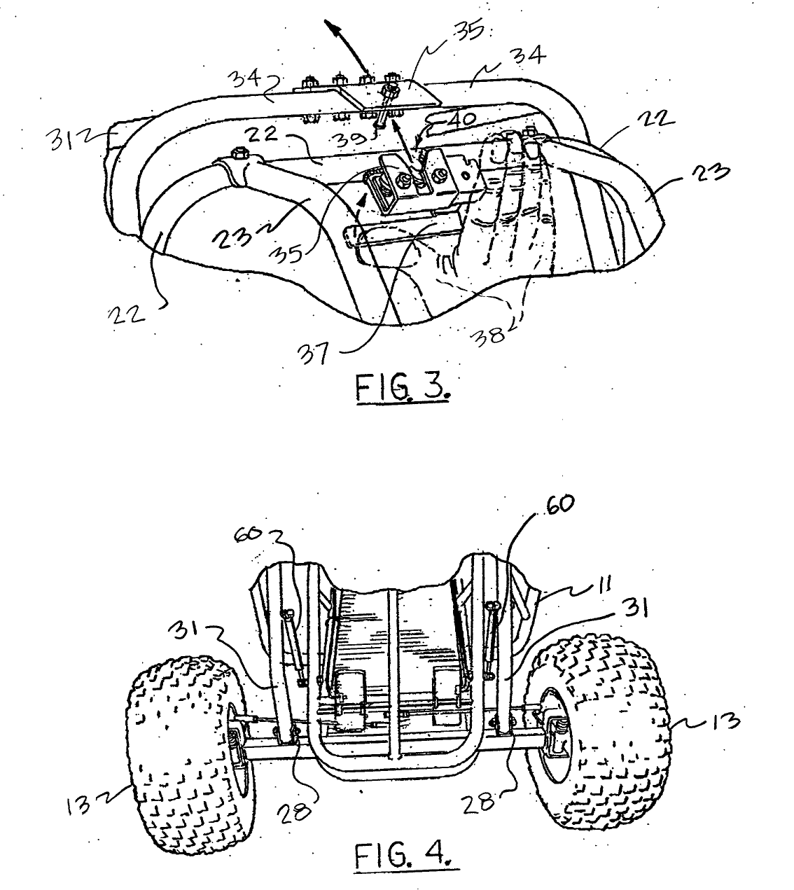

Pneumatic telescoping cylinders 60 can be used to aid in the lifting of cage 30 with respect to chassis 11. The pneumatic cylinder 60 has one end portion that can be attached to a plate that is welded to chassis 11 or can be bolted directly to chassis 11. At its opposite end portion, each pneumatic telescoping cylinder 60 is preferably bolted to the lower end of cage 30 at longitudinal member 31 as shown in FIG. 4.

A body panel (eg. plastic or fiberglass) can be optionally provided that covers the front end portion of the cart apparatus 10, namely that portion that extends in front of the seat 15 and under cage 30.

The following is a summary list of the parts and corresponding descriptions that are used in the written specification.

PARTS LIST

| Part Number | Description |
|---|---|
| 10 | small motorized cart |
| 10a | small motorized cart |
| 11 | chassis |
| 11a | chassis |
| 12 | engine |
| 13 | front wheel |
| 14 | rear wheel |
| 15 | seat |
| 16 | seat back |
| 17 | seat base |
| 18 | rail |
| 19 | engine guard |
| 20 | horizontal tube |
| 21 | diagonal tube |
| 22 | seat back tube |
| 23 | rear tube |
| 24 | steering bar |
| 25 | steering column |
| 26 | steering mechanism |
| 27 | steering column support |
| 28 | pivot |
| 29 | arrow |
| 30 | brush cage |
| 31 | primary longitudinal tube |
| 32 | secondary longitudinal tube |
| 33 | transverse tube |
| 34 | transverse tube |
| 35 | latch plate |
| 36 | latch member |
| 37 | locking arm |
| 38 | user's hand |
| 39 | post |
| 40 | slot |
| 41 | |
| 42 | steering bar |
| 43 | handle |
| 44 | upper steering column section |
| 45 | sleeve |
| 46 | axle |
| 47 | lower steering column section |
| 48 | universal joint |
| 49 | steering lever |
| 50 | rod |
| 51 | welded connection |
| 52 | weld elbow |
| 53 | concavity |
| 54 | elbow |
| 55 | concavity |

The foregoing embodiments are presented by way of example only; the scope of the present invention is to be limited only by the following claims.

1. A go cart apparatus comprising;
a) a chassis having a fixed portion that includes seat base and seat back portions, a plurality of wheels including front steerable wheels and rear wheels, and a seat back tube that extends to an elevated position above the seat back;
b) an engine mounted on the chassis behind the seat back;
c) a steering mechanism for steering the front wheels and including a steering member positioned next to the seat and above the seat base;
d) the chassis including a brush cage that is a movable part of the chassis mounted to the chassis at the front of the chassis next to the front wheels and movable between lowered and elevated positions, the cage including an inclined portion that extends from a lower position next to the front wheels to a higher position above and behind the steering member; and
e) a locking mechanism on the chassis that locks the cage to the chassis in the lowered position.

2. The go cart apparatus of claim 1 wherein the locking mechanism is positioned on the chassis generally above the seat.

3. The go cart apparatus of claim 1 wherein the locking mechanism includes first and second locking members that include one locking member mounted on the fixed portion of the chassis and another locking member mounted on the movable cage part of the chassis.

4. The go cart apparatus of claim 1 wherein the seat back tube extends along opposing sides of the seat back and includes a generally transverse tube member that is positioned at the top of seat back member.

5. The go cart apparatus of claim 3 wherein the seat back tube extends along opposing sides of the seat back and further comprising a generally transverse tube member that is positioned at the top of seat back member.

6. The go cart apparatus of claim 5 wherein one of the locking members is attached to the transverse tube member.

7. The go cart apparatus of claim 1 wherein the cage is comprised of a pair of primary tube members and a pair of secondary tube members, each secondary tube member being connected at spaced apart positions to a primary tube member, wherein the primary tube members are movably attached to the chassis.

8. The go cart apparatus of claim 1 wherein the cage is comprised of a pair of primary tube members and a pair of secondary tube members, each secondary tube member being connected at spaced apart positions to a primary tube member, wherein the primary tube members are pivotally attached to the chassis.

9. The go cart apparatus of claim 1 wherein the cage is a movable part of the chassis pivotally attached to the fixed part of the chassis.

10. A go cart apparatus comprising;
a) a chassis having a seat with seat base and seat back portions, a plurality of wheels including front steerable wheels and rear wheels, and a seat back tube that extends to an elevated position;
b) an engine mounted on the chassis behind the seat back;
c) a steering mechanism for steering the front wheels and including a steering member positioned next to the seat and above the seat base;
d) a brush cage that is movably mounted to the chassis at the front of the chassis and next to the front wheels, the brush cage being movable relative to the chassis between lowered and elevated positions, the cage including an inclined portion that extends from a position next to the front wheels to a position above and behind the steering member; and
e) a locking mechanism that locks the cage to the chassis in the lowered position.

11. The go cart apparatus of claim 10 wherein the locking mechanism is positioned above the seat when the case is in the lowered position.

12. The go cart apparatus of claim 10 wherein the locking mechanism includes first and second locking members that include one locking member mounted on the chassis and another locking member mounted on the cage.

13. The go cart apparatus of claim 10 wherein the seat back tube extends along opposing sides of the seat back and further comprising a generally transverse tube member that is positioned at the top of seat back member.

14. The go cart apparatus of claim 13 wherein the seat back tube extends along opposing sides of the seat back and further comprising a generally transverse tube member that is positioned at the top of seat back member.

15. The go cart apparatus of claim 14 wherein one of the locking members is attached to the transverse tube member.

16. The go cart apparatus of claim 10 wherein the cage is comprised of a pair of primary tube members and a pair of secondary tube members, each secondary tube member being connected at spaced apart positions to a primary tube member, wherein the primary tube members are movably attached to the chassis.

17. The go cart apparatus of claim 10 wherein the cage is comprised of a pair of primary tube members and a pair of secondary tube members, each secondary tube member being connected at spaced apart positions to a primary tube member, wherein the primary tube members are pivotally attached to the chassis.

18. The go cart apparatus of claim 10 wherein the cage is comprised of a pair of primary tube members pivotally mounted to the frame at a position next to the front wheels and behind the front shock absorbers and a pair of secondary tube members, each secondary tube member being connected at spaced apart positions to a primary tube member, wherein the primary tube members are pivotally attached to the chassis.

19. The go cart apparatus of claim 18 wherein the cage is further comprised of at least one transverse tube that connects the primary tube members.

20. A go cart apparatus comprising;
a) a chassis having front and rear portions, a seat with seat base and seat back portions, a plurality of wheels including front steerable wheels and rear wheels, and a seat back tube that extends to an elevated position above the seat back, and a pair of swinging arms that extend respectively from each front wheel to a position behind the front wheel to a swing arm pivot point;
b) an engine mounted on the rear portion of the chassis, behind the seat back;
c) a steering mechanism on the chassis for steering the front wheels and including a steering member positioned next to the seat and above the seat base;
d) foot pedals on the chassis for braking the wheels and throttling the engine;
e) a brush cage that is movably mounted to the chassis between lowered and elevated positions, the cage including an inclined portion that extends from a position next to the front portion of the chassis to a position above and behind the steering member; and
f) a locking mechanism that locks the cage in the lowered position.

21. The go cart apparatus of claim 20 wherein the foot pedals are positioned behind the front wheels.

22. The go cart apparatus of claim 20 wherein the brush cage is attached to the chassis with pivotal connections that are in front of the pedals.

23. The go cart apparatus of claim 22 wherein there are two pivotal connections, each pivotal connection being positioned on the chassis generally in between a pedal are a front wheel.

24. The go cart apparatus of claim 22 wherein each pivotal connection is positioned on the chassis next to a front wheel.

25. The go cart apparatus of claim 20 wherein the brush cage is attached to the chassis at a position next to the front wheels.
